(19) United States
(12) Patent Application Publication
(10) Pub. No.: US 2023/0385490 A1
(43) Pub. Date: Nov. 30, 2023

(54) HYDROLOGICAL MODEL CONSIDERING UNCERTAINTY OF RUNOFF PRODUCTION STRUCTURE AND METHOD FOR QUANTIFYING ITS IMPACT ON SURFACE-SUBSURFACE HYDROLOGICAL PROCESS

(71) Applicant: NANJING HYDRAULIC RESEARCH INSTITUTE, Jiangsu (CN)

(72) Inventors: Junliang Jin, Jiangsu (CN); Zhangkang Shu, Jiangsu (CN); Jianyun Zhang, Jiangsu (CN); Lin Wang, Jiangsu (CN); Guoqing Wang, Jiangsu (CN); Zhenxin Bao, Jiangsu (CN); Yanli Liu, Jiangsu (CN); Cuishan Liu, Jiangsu (CN); Ruimin He, Jiangsu (CN); Qiuwen Chen, Jiangsu (CN); Zhiyuan Wang, Jiangsu (CN)

(73) Assignee: NANJING HYDRAULIC RESEARCH INSTITUTE, Jiangsu (CN)

(21) Appl. No.: 18/323,363

(22) Filed: May 24, 2023

(30) Foreign Application Priority Data
May 31, 2022 (CN) 202210613754.9

(51) Int. Cl. G06F 30/28

(52) U.S. Cl. CPC G06F 30/28; G06F 2111/06

(57) ABSTRACT

The present invention discloses a hydrological model considering the uncertainty of a runoff production structure and a method for quantifying influence on a surface-subsurface hydrological process. The present invention quantifies the uncertainty of runoff production structures including a surface runoff structure, an interflow structure and a base flow structure by using parameters, and constructs a hydrological model considering the uncertainty of a runoff production structure by combining an added confluence module. Compared with an original hydrological model, the hydrological model has higher precision, which is capable to quantify the uncertainty of surface runoff, interflow and base flow of the runoff production structure and its impact on the surface-subsurface hydrological process, better improve precision of runoff simulation, and enhance understanding and cognition of the basic rule of a hydrological physical process.

### CROSS-REFERENCE TO RELATED APPLICATION

This application claims the priority benefit of China application serial no. 202210613754.9, filed on May 31, 2022. The entirety of the above-mentioned patent application is hereby incorporated by reference herein and made a part of this specification.

### TECHNICAL FIELD

The present invention relates to the technical field of hydrological models, and particularly relates to a hydrological model considering the uncertainty of a runoff production structure and a method for quantifying its impact on a surface-subsurface hydrological process.

### BACKGROUND ART

The watershed hydrological model is a mathematical model constructed to simulate the water cycle process of a watershed and used to describe the hydrological physical process, an important means to explore and understand the water cycle and hydrological process, and also an effective tool for solving practical problems of hydrological forecasting, water resource planning and management, hydrological analysis and calculation, etc. The core of hydrological modeling of the watershed lies in the characterization of hydrological processes such as runoff production and confluence, and starting from different understanding and characterization of the principles of runoff production and confluence in the hydrological process, hydrological models with different structures and modeling methods are generated. Therefore, the hydrological models inevitably have structural uncertainty, and the description and quantitative characterization of the uncertainty of a hydrological model structure is an important link to improve the structure of the hydrological model and improve the accuracy of simulating the surface-subsurface hydrological process of the watershed.

At present, in the field of hydrological models, a plurality of models are usually combined to analyze the uncertainty of a model structure. Usually, hydrological models with different structures are selected to simulate the runoff process of a watershed, and then a certain post-processing method is used according to the simulation results of various models to quantitatively analyze the uncertainty of the model structure. However, according to the post-processing method, differences in the results of different models are generally described as being caused by the uncertainty of the model structure, and the uncertainty in model parameters, a model runoff production structure and a confluence structure is uniformly regarded as the uncertainty of the hydrological model structure, resulting in that it is impossible to analyze the uncertainty of a specific process (such as the runoff production process of a model, particularly the runoff components of the runoff production process such as surface runoff, interflow and base flow), as well as its impact on simulation of the surface-subsurface hydrological process; at the same time, the computational cost of using different model structures is high, and the practical application and operability in real operations are low. A Chinese patent with the application number of 202111312143.2 proposes a hydrological model structure diagnosis method based on time-varying parameters, but this method can only be used to diagnose the applicability of the hydrological model structure, and fails to quantify the uncertainty of the model structure, particularly the runoff production structure. A Chinese patent with the application number of 201610149128.3 proposes a comprehensive uncertainty analysis method for hydrological models based on the Copula function, but this method can only take into account the comprehensive the uncertainty of hydrological model parameters and structures, and fails to quantify the uncertainty of a runoff production structure in a targeted manner and its impact on simulation of the hydrological process. Therefore, in most cases, a watershed hydrological model is required, which is capable to characterize the runoff production structure uncertainty, particularly to deeply analyze the uncertainty of runoff production structures such as a surface runoff structure, an interflow structure and a base flow structure, and to quantitatively analyze the impact of runoff production structure uncertainty on simulation of the hydrological process.

### SUMMARY

In view of the disadvantage that existing hydrological models and uncertainty estimation methods cannot be used to analyze the uncertainty of a model runoff production structure and its impact, an objective of the present invention is to provide an improved hydrological model based on the SIMHYD model (simplified version of the HYDROLOG model), which can quantify the impact of the uncertainty of runoff production structures including a surface runoff structure, an interflow structure and a base flow structure on the surface-subsurface hydrological process.

The present invention provides a hydrological model considering the uncertainty of a runoff production structure, and the model includes the following steps:
S(1) collecting data: collecting the observation sequence of hydrometeorological stations in a watershed, including the data of precipitation, water surface evaporation and runoff observed by the stations in the watershed.
S(2) calculating runoff production: establishing a runoff production calculation module based on the structure of the SIMHYD model, and mainly calculating the evaporation loss, soil infiltration, water storage and runoff production.
1) Evaporation loss calculation: the evaporation loss includes three parts, i.e., evaporation of intercepted precipitation on vegetated surfaces, evaporation of soil water and evaporation of precipitation on impervious surfaces, where the intercepted precipitation on vegetated surfaces and the precipitation on impervious surfaces are calculated according to the rate of evaporation, while the evaporation of soil water is calculated according to the soil water content and the remaining evaporation capacity, and a computation formula is as follows:

$${ET}_{1} = min ( INS , PET )$$

$$ET = min ( 10 \times \frac{SMS}{SMSC} , POT )$$

$$POT = PET - {ET}_{1}$$

where ET₁ represents the evaporation of intercepted precipitation on vegetated surfaces and precipitation on impervious surfaces; ET is the evaporation of soil water; INS is the cumulative amount of intercepted precipitation on vegetated surfaces, which is calculated according to the water balance relationship; PET is the potential evapotranspiration, which is generally substituted by the measured evaporation from water surfaces; SMS denotes the soil moisture storage; SMSC is the soil moisture storage capacity; and POT is the potential evapotranspiration.
2) Soil infiltration calculation: assuming that there is a negative power exponent relationship between the infiltration rate and the soil water content, the formula is as follows:

$$RMO = min ( INF , INR )$$

$$INF = COEFF \times {e}^{( - SQ \times \frac{SMS}{SMSC} )}$$

$$INR = max [ ( RAIN + INS - INSC ) , 0 ]$$

where INF is the infiltration rate; COEFF is the maximum infiltration loss, mm; SQ is an infiltration loss index; INR is the amount of precipitation after deducting the intercepted precipitation on vegetated surfaces, that is, the amount of water stored on vegetated surfaces; RAIN is the temporal precipitation; INSC is a parameter of intercepted precipitation storage capacity; and RMO is the soil infiltration capacity.
3) Calculation of water storage volume: including the amount of water stored on vegetated surfaces (INR), soil moisture storage and subsurface water storage, where soil moisture storage is the most important intermediate state variable, which determines the calculation of interflow and subsurface water replenishment. The formula for calculating soil moisture storage and subsurface water storage is as follows:

$$REC = CRAK \times \frac{SMS}{SMSC} \times ( RMO - SRUN )$$

$$SMF = RMO - SRUN - REC$$

where REC represents the subsurface water storage replenishment; SMF denotes the soil moisture storage replenishment; and CRAK is a subsurface water replenishment coefficient.
4) Runoff calculation: the model includes three runoff components, that is, surface runoff, interflow and base flow, and the specific calculations are as follows:

$$IRUN = INR - RMO$$

$$SRUN = SUB \times \frac{SMS}{SMSC} \times RMO$$

$$BAS = Kg \times GW$$

where IRUN denotes the surface runoff; SRUN represents the interflow; BAS is the base flow; SUB is an interflow outflow coefficient; Kg is a subsurface runoff coefficient; and GW is the subsurface water storage.
S(3) dealing with the uncertainty of a runoff production structure: it is assumed that the differences between the runoff yields of different runoff components of the SIMHYD model and the real runoff yields follow a normal distribution, that is, the product of multiplying the runoff yield of each of the three runoff components (surface runoff, interflow and base flow) of the SIMHYD model with a random number following the normal distribution is equal to the corresponding real runoff yield.

For the surface runoff, a random number following the normal distribution can be quantitatively expressed as a random number of normal distribution with a mean of m_{IRUN} and a variance of δ²_{IRUN}. For the interflow, a random number following the normal distribution can be quantitatively expressed as a random number of normal distribution with a mean of m_{SRUN} and a variance of δ²_{SRUN}. For the base flow, a random number following the normal distribution can be quantitatively expressed as a random number of normal distribution with a mean of m_{BAS} and a variance of δ²_{BAS}.

Taking m_{IRUN}, m_{SRUN}, m_{BAS}, δ²_{IRUN}, δ²_{SRUN} and δ²_{BAS} as model parameters, an optimization algorithm is used to solve them, where variances δ²_{IRUN}, δ²_{SRUN} and δ²_{BAS} can represent the uncertainty of the runoff production structures including the surface runoff structure, the interflow structure and the base flow structure. Three functions considering the uncertainty of the runoff production structures are expressed as:

IRŨNₜ=ϕ_{IRUN}×IRUNₜ ϕ_{IRUN}˜N(m_{IRUN},δ²_{IRUN})

SRŨNₜ=ϕ_{SRUN}×SRUNₜ ϕ_{SRUN}˜N(m_{SRUN},δ²_{SRUN})

BÃSₜ=ϕ_{BAS}×BASₜ ϕ_{BAS}˜N(m_{BAS},δ²_{BAS})

where N (a,b) represents a mathematical expression of normal distribution with a mean of a and a variance of b; IRUNₜ represents the surface runoff calculated by the model at time t, SRUNₜ represents the interflow calculated by the model at time t, BASₜ represents the base flow calculated by the model at time t, IRŨNₜ represents the actual surface runoff at time t, SRŨNₜ represents the actual interflow at time t, BÃSₜ, represents the actual base flow at time t, and ϕ_{IRUN}, ϕ_{SRUN} and ϕ_{BAS} respectively represent the random multipliers of the surface runoff, the interflow and the base flow.
S(4) calculating the confluence: the original SIMHYD model involves no confluence part of any river channel, and it is only required to superimpose the runoff yields of the three runoff components to obtain the runoff at an outlet of the watershed.

For direct superposition of the three runoff components to obtain the runoff at the outlet of the watershed, the confluence process of water flow in the river channel is not taken into account, however, river channel confluence is very important for the accurate simulation of a high-flow process.

In this scheme, a lag-and-route method is used to adjust the total outflow process of the SIMHYD model considering the uncertainty of the runoff production structure, so as to consider the river channel confluence. The formula is as follows:

Qₜ=CR×Qₜ₋₁+(1−CR)×(IRŨNₜ+SRŨNₜ+BÃSₜ)

where Qₜ is the flow rate at the outlet of the watershed at time t, m³/s; and CR is a coefficient of extinction.

The use of the lag-and-route method to adjust the total outflow, compared with the only superposition of runoff yields of the three runoff components, improves the consideration of the confluence process of the watershed, and can improve the simulation of the high-flow process by use of the hydrological model.
S(5) optimizing parameters: selecting the runoff sequence observed by the hydrometeorological stations at the outlet of the watershed in a continuous year, defining the calibration period and validation period, taking the runoff sequence observed by the hydrometeorological stations at the outlet of the watershed as a standard sequence, using a NSE coefficient as an objective function, taking the maximization of the NSE coefficient as an optimization objective, using the Shuffled Complex Evolution (SCE-UA) algorithm as a global optimization algorithm, inputting the average areal precipitation in the watershed in the calibration period, average areal evaporation from water surface and runoff at an outlet of the watershed, and setting the upper and lower boundary values for the parameters to be optimized, to obtain optimized model parameters.

Based on the seven parameters of the original SIMHYD model, including the intercepted precipitation storage capacity, the maximum infiltration loss, the soil moisture storage capacity, the interflow outflow coefficient, the infiltration loss index, the subsurface water replenishment coefficient and the subsurface runoff coefficient, the present invention increases the m_{IRUN}, m_{SRUN}, m_{BAS}, δ²_{IRUN}, δ²_{SRUN}, δ²_{BAS} and CR parameters, and improves the consideration of the runoff production structure uncertainty and the confluence part of any river channel, which can well estimate the impact of runoff production structure uncertainty on runoff simulation and improve the effect of runoff simulation.
S(6) substituting the optimized parameter values into the validation period to calculate and obtain the values of simulated runoffs in the calibration period and the validation period.

Further, in S(5), the average areal precipitation in the watershed in the calibration period, the average areal evaporation from water surface and the runoff at an outlet of the watershed are inputted, that is, the precipitation and evaporation from water surface observed by the hydrometeorological stations in the watershed in S(1) are converted to the average areal precipitation in the watershed and the average areal evaporation from water surface, and a multi-site arithmetic averaging method is adopted as the conversion method:

$${\overline{PE}}_{t} = {{\sum }^{n}}_{i} {PE}_{i , t} / n$$

where PE_{i,t} represents the precipitation or evaporation from water surface observed by a station i at time t, n represents the total number of stations in the watershed, and PĒₜ represents the average areal precipitation in the watershed or the evaporation from water surface at time t.

A method for quantifying the impact of the uncertainty of a runoff production structure on a surface-subsurface hydrological process uses random Monte Carlo sampling to simulate the impact of runoff production structure uncertainty on the surface-subsurface hydrological process; in this scheme, the uncertainty of the runoff production structures such as a surface runoff structure, an interflow structure and a base flow structure can be expressed by random multipliers, the variances δ²_{IRUN}, δ²_{SRUN} and δ²_{BAS} of the random multipliers represent the runoff production structure the uncertainty of their respective runoff components, and the impact of the runoff production structure uncertainty on the surface-subsurface hydrological process can be obtained based on the optimized variances δ²_{IRUN}, δ²_{SRUN} and δ²_{BAS}.

Specifically, for the surface runoff simulation that considers the uncertainty of the surface runoff production structure, after parameter optimization, an estimated value IRŨNₜ of the surface runoff is randomly generated from the normal distribution g(IRŨNₜ|IRUNₜ,δ_{IRUN}²×IRUNₜ) with a mean of IRUNₜ and a variance of δ²_{IRUN}×IRUNₜ, and cyclic sampling is performed N times to obtain the quantitative estimate of the impact of the surface runoff production structure uncertainty on the surface runoff. Similarly, for the interflow simulation that considers the uncertainty of the interflow runoff production structure, after parameter optimization, an estimated value SRŨNₜ of the interflow is randomly generated from the normal distribution g(SRŨNₜ|SRUNₜ,δ_{SRUN}²×SRUNₜ) with a mean of SRUNₜ and a variance of δ²_{SRUN}×SRUNₜ, and cyclic sampling is performed N times to obtain the quantitative estimate of the impact of the interflow runoff production structure uncertainty on the interflow. Similarly, for the base flow simulation that considers the uncertainty of the base flow production structure, after parameter optimization, an estimated value BÃSₜ of the base flow is randomly generated from the normal distribution g(BÃSₜ|BASₜ,δ_{BAS}²×BASₜ) with a mean of BASₜ and a variance of δ²_{BAS}×BASₜ, and cyclic sampling is performed N times to obtain the quantitative estimate of the impact of the base flow production structure uncertainty on the base flow.

The runoff the uncertainty of the three runoff components will also have an impact on the simulation and prediction of the flow rate at the outlet of the watershed, according to the estimate results about the uncertainty of the runoff yield of each of the three runoff components (surface runoff, interflow and base flow), the three kinds of runoff components, in the same sampling scenario, are superimposed to obtain the runoff yield of the whole watershed, and then according to the watershed confluence formula and the optimized confluence parameters, the flow rates at the outlet of the watershed under different random sampling scenarios are calculated to obtain N kinds of processes of flow at the outlet of the watershed, which represents the impact of runoff production structure uncertainty on simulation of the flow rate at the outlet of the watershed.

In a preferred embodiment, N is set to 1000, that is, cyclic sampling is performed for 1000 times.

The present invention has the beneficial effects as follows:

The present invention quantifies the uncertainty of runoff production structures including a surface runoff structure, an interflow structure and a base flow structure by using parameters, and constructs a hydrological model considering the uncertainty of a runoff production structure by combining an added confluence module. Compared with an original hydrological model, the hydrological model has higher precision, which is capable to quantify the uncertainty of surface runoff, interflow and base flow of the runoff production structure and its impact on the surface-subsurface hydrological process, better improve precision of runoff simulation, and enhance understanding and cognition of the basic rule of a hydrological physical process.

### BRIEF DESCRIPTION OF THE DRAWINGS

FIG. 1 is a structural diagram of a model of the present invention;

FIG. 2 shows a quantitative estimate result of the impact of the uncertainty of a surface runoff production structure on a surface runoff;

FIG. 3 shows a quantitative estimate result of the impact of the uncertainty of an interflow runoff production structure on an interflow;

FIG. 4 shows a quantitative estimate result of the impact of the uncertainty of a base flow runoff production structure on a base flow;

FIG. 5 shows contribution ratios of uncertainties of different runoff production structures in the present invention including a surface runoff structure, an interflow structure and a base flow structure to runoff production uncertainty; and

FIG. 6 shows the impact from variation of flow rates at an outlet of the watershed and the uncertainty of a runoff production structure simulated by the present invention.

### DETAILED DESCRIPTION OF THE EMBODIMENTS

The technical solutions of the present invention will be described in detail below by means of embodiments and in conjunction with the accompanying drawings, but such embodiments are not to be construed as limiting the scope of protection of the present invention.

In this embodiment, calculation is performed based on the data of the Chitan watershed in the upper reaches of Jinxi, Fujian Province from 2013 to 2017, including the precipitation, measured evaporation from water surface and runoff In the specific operation, 2013-2015 is the calibration period of a hydrological model in which the parameters of the model are optimized and calibrated, and 2016-2017 is the verification period in which the effect and usability of the hydrological model are validated.

### Embodiment 1

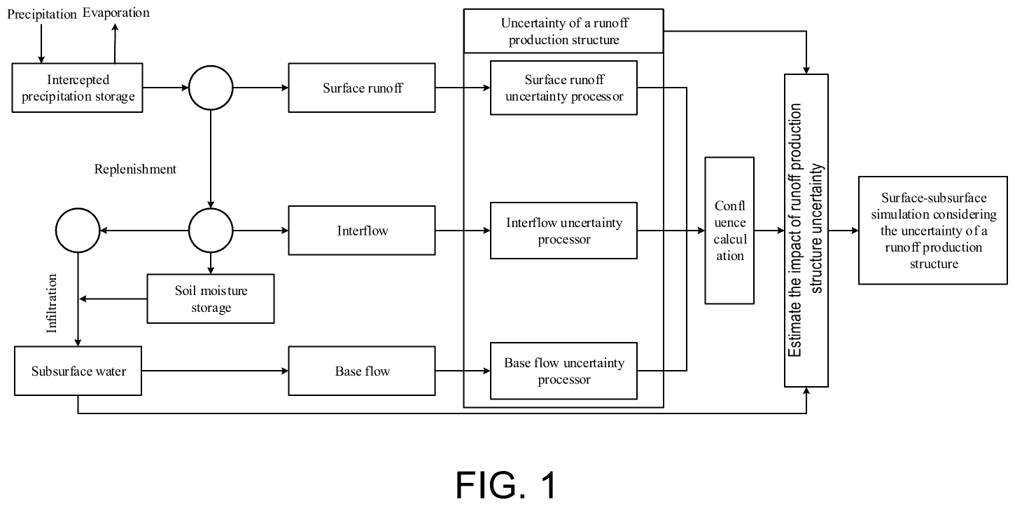

As shown in FIG. 1, a hydrological model considering the uncertainty of a runoff production structure includes the following steps:
S(1) collecting data: the observation sequence of hydrometeorological stations in a watershed is collected, including the data of precipitation, water surface evaporation and runoff observed by the stations in the watershed.

The observation data of the hydrometeorological stations in the watershed are collected, the precipitation and evaporation from water surface observed by the hydrometeorological stations in the watershed are required to be converted to the average areal precipitation in the watershed and the average areal evaporation from water surface, and a multi-site arithmetic averaging method is adopted as the conversion method:

$${\overline{PE}}_{t} = {{\sum }^{n}}_{i} {PE}_{i , t} / n$$

where PE_{i,t} represents the precipitation or evaporation from water surface observed by a station i at time t, n represents the total number of stations in the watershed, and PĒₜ represents the average areal precipitation in the watershed or the average areal evaporation from water surface at time t.

Table 1 shows the average areal precipitation in the Chitan watershed, the average areal evaporation from water surface and the runoff at an outlet of the watershed that are inputted into the model after conversion (partial).

TABLE 1

| | | | Average | Evaporation | |
|---|---|---|---|---|---|
| | | | areal | from water | |
| | | | precipitation | surface | Runoff |
| Year | Month | Day | (mm) | (mm) | (m³/s) |
| 2013 | 1 | 1 | 0 | 1.20 | 120.90 |
| 2013 | 1 | 2 | 0.44 | 7.60 | 112.90 |
| 2013 | 1 | 3 | 0.89 | 0.90 | 112.90 |
| 2013 | 1 | 4 | 6.61 | 0.70 | 121.10 |
| 2013 | 1 | 5 | 1.67 | 0.70 | 133.30 |
| 2013 | 1 | 6 | 0.11 | 0.40 | 129.10 |
| . . . | . . . | . . . | . . . | . . . | . . . |
| 2016 | 4 | 16 | 20.89 | 2 | 845 |
| 2016 | 4 | 17 | 35.72 | 2.30 | 777 |
| 2016 | 4 | 18 | 0.39 | 1.80 | 954.70 |
| 2016 | 4 | 19 | 5.22 | 1.70 | 522.20 |
| 2016 | 4 | 20 | 6.22 | 1.40 | 476.20 |
| 2016 | 4 | 21 | 6.22 | 1.70 | 513.70 |
| . . . | . . . | . . . | . . . | . . . | . . . |
| 2017 | 12 | 26 | 0 | 1.40 | 88.76 |
| 2017 | 12 | 27 | 0.12 | 0.90 | 35.52 |
| 2017 | 12 | 28 | 0.48 | 0.80 | 43.06 |
| 2017 | 12 | 29 | 0 | 0.90 | 34.14 |
| 2017 | 12 | 30 | 0.13 | 1.70 | 35.65 |
| 2017 | 12 | 31 | 0 | 0.70 | 34.14 |

S(2) calculating runoff production: a runoff production calculation module based on the structure of the SIMHYD model is established, and the evaporation loss, soil infiltration, water storage and runoff production are mainly calculated.
1) Evaporation loss calculation: the evaporation loss includes three parts, i.e., evaporation of intercepted precipitation on vegetated surfaces, evaporation of soil water and evaporation of precipitation on impervious surfaces, where the evaporation from the intercepted precipitation on vegetated surfaces and the precipitation on impervious surfaces are calculated according to the rate of evaporation, while the evaporation of soil water is calculated according to the soil water content and the remaining evaporation capacity, and a computation formula is as follows:

$${ET}_{1} = min ( INS , PET )$$

$$ET = min ( 10 \times \frac{SMS}{SMSC} , POT )$$

$$POT = PET - {ET}_{1}$$

where ET1 represents the evaporation of intercepted precipitation on vegetated surfaces and precipitation on impervious surfaces; ET is the evaporation of soil water; INS is the cumulative amount of intercepted precipitation on vegetated surfaces, which is calculated according to the water balance relationship; PET is the potential evapotranspiration, which is generally substituted by the evaporation from water surfaces; SMS denotes the soil moisture storage; SMSC is the soil moisture storage capacity; and POT is the potential evapotranspiration.
2) Soil infiltration calculation: it is assumed that there is a negative power exponent relationship between the infiltration rate and the soil water content, and the formula is as follows:

$$RMO = min ( INF , INR )$$

$$INF = COEFF \times {e}^{( - SQ \times \frac{SMS}{SMSC} )}$$

$$INR = max [ ( RAIN + INS - INSC ) , 0 ]$$

where INF is the infiltration rate; COEFF is the maximum infiltration loss, mm; SQ is an infiltration loss index; INR is the amount of precipitation after deducting the intercepted precipitation on vegetated surfaces; RAIN is the temporal precipitation; INSC is a parameter of intercepted precipitation storage capacity; and RMO is the soil infiltration capacity.
3) Calculation of water storage volume: the amount of water stored on vegetated surfaces, soil moisture storage and subsurface water storage are included, where soil moisture storage is the most important intermediate state variable, which determines the calculation of interflow and subsurface water replenishment. The formula for calculating soil moisture storage and subsurface water storage is as follows:

$$REC = CRAK \times \frac{SMS}{SMSC} \times ( RMO - SRUN )$$

$$SMF = RMO - SRUN - REC$$

where REC represents the subsurface water storage replenishment; SMF denotes the soil moisture storage replenishment; CRAK is a subsurface water replenishment coefficient; and SRUN represents the interflow.
4) Runoff calculation: three runoff components are included, that is, surface runoff, interflow and base flow, and the specific calculations are as follows:

$$IRUN = INR - RMO$$

$$SRUN = SUB \times \frac{SMS}{SMSC} \times RMO$$

$$BAS = Kg \times GW$$

where IRUN denotes the surface runoff; SRUN represents the interflow; BAS is the base flow; SUB is an interflow outflow coefficient; Kg is a subsurface runoff coefficient; and GW is the subsurface water storage.
S(3) dealing with the uncertainty of a runoff production structure: it is assumed that the differences between the runoff yields of different runoff components of the SIMHYD model and the real runoff yields follow a normal distribution, that is, the product of multiplying the runoff yield of each of the three runoff components (surface runoff, interflow and base flow) of the SIMHYD model with a random number following the normal distribution is equal to the corresponding real runoff yield.

Here, for the surface runoff, a random number following the normal distribution can be quantitatively expressed as a random number of normal distribution with a mean of m_{IRUN} and a variance of δ²_{IRUN}. For the interflow, a random number following the normal distribution can be quantitatively expressed as a random number of normal distribution with a mean of m_{SRUN} and a variance of δ²_{SRUN}. For the base flow, a random number following the normal distribution can be quantitatively expressed as a random number of normal distribution with a mean of m_{BAS} and a variance of δ²_{BAS}.

Taking m_{IRUN}, m_{SRUN}, m_{BAS}, δ²_{IRUN}, δ²_{SRUN} and δ²_{BAS} as model parameters, an optimization algorithm is directly used to solve them, and the parameter results after solving are shown in Table 2. Variances δ²_{IRUN}, δ²_{SRUN} and δ²_{BAS} can represent the uncertainty of the runoff production structures including the surface runoff structure, the interflow structure and the base flow structure. Three functions considering the uncertainty of the runoff production structures are expressed as:

IRŨNₜ=ϕ_{IRUN}×IRUNₜ ϕ_{IRUN}˜N(m_{IRUN},δ²_{IRUN})

SRŨNₜ=ϕ_{SRUN}×SRUNₜ ϕ_{SRUN}˜N(m_{SRUN},δ²_{SRUN})

BÃSₜ=ϕ_{BAS}×BASₜ ϕ_{BAS}˜N(m_{BAS},δ²_{BAS})

where IRUNₜ, represents the surface runoff calculated by the model at time t, SRUNₜ represents the interflow calculated by the model at time t, BASₜ represents the base flow calculated by the model at time t, IRŨNₜ represents the actual surface runoff at time t, SRŨNₜ represents the actual interflow at time t, BÃSₜ represents the actual base flow at time t, and ϕ_{IRUN}, ϕ_{SRUN} and ϕ_{BAS} respectively represent the random multipliers of the surface runoff, the interflow and the base flow.
S(4) calculating the confluence: the original SIMHYD model involves no confluence part of any river channel, and it is only required to superimpose the runoff yields of the three runoff components to obtain the runoff at an outlet of the watershed. In this scheme, a lag-and-route method is used to adjust the total outflow process of the SIMEIYD model considering the uncertainty of the runoff production structure, so as to consider the river channel confluence. The formula is as follows:

Qₜ=CR×Qₜ₋₁+(1−CR)×(IRŨNₜ+SRŨNₜ+BÃSₜ)

where Qt is the flow rate at the outlet of the watershed at time t, m³/s; and CR is a coefficient of extinction for channel storage.
S(5) optimizing parameters: the runoff sequence observed by the hydrometeorological stations at the outlet of the watershed is taken as a standard sequence, 2013-2015 is selected as the calibration period of the model, a NSE coefficient is used as an objective function, the maximization of the NSE coefficient is taken as an optimization objective, the Shuffled Complex Evolution (SCE-UA) algorithm is used as a global optimization algorithm, the average areal precipitation in the watershed in the calibration period, evaporation from water surface and runoff at an outlet of the watershed (Table 1) are inputted, the upper and lower boundary values for the 14 parameters optimized are set, the hydrological model parameters are optimized, and the optimized parameters and optimized values are shown in Table 2.

TABLE 2

| Symbolic | | Optimal |
|---|---|---|
| parameter | Meaning | value |
| INSC | Intercepted precipitation storage capacity | 4.3851 |
| COEFF | Maximum infiltration loss | 311.71 |
| SMSC | Soil moisture storage capacity | 372.38 |
| SUB | Interflow outflow coefficient | 0.6568 |
| SQ | Infiltration loss index | 9.733 |
| CRAK | Subsurface water replenishment coefficient | 0.5362 |
| Kg | Subsurface runoff coefficient | 0.0219 |
| M_{IRUN} | Mean random multiplier of the surface runoff | 0.8096 |
| M_{SRUN} | Mean random multiplier of the interflow | 1.8208 |
| m_{BAS} | Mean random multiplier of the base flow | 0.9169 |
| δ²_{IRUN} | Variance of a random multiplier of the surface | 0.0792 |
| | runoff | |
| δ²_{SRUN} | Variance of a random multiplier of the interflow | 0.5388 |
| δ²_{BAS} | Variance of a random multiplier of the base flow | 0.3212 |
| CR | Coefficient of extinction for channel storage | 0.7333 |

S(6), the optimized parameter values are substituted into the validation period of 2016-2017 to calculate, and the calculation results for part of the calibration period and validation period are shown in Table 3:

TABLE 3

| | | | Measured | Simulated |
|---|---|---|---|---|
| Year | Month | Day | runoff (m³/s) | runoff |
| 2013 | 1 | 1 | 120.90 | 160.85 |
| 2013 | 1 | 2 | 112.90 | 147.62 |
| 2013 | 1 | 3 | 112.90 | 141.89 |
| 2013 | 1 | 4 | 121.10 | 126.96 |
| 2013 | 1 | 5 | 133.30 | 101.23 |
| 2013 | 1 | 6 | 129.10 | 106.06 |
| . . . | . . . | . . . | . . . | . . . |
| 2016 | 4 | 16 | 845 | 689.78 |
| 2016 | 4 | 17 | 777 | 846.37 |
| 2016 | 4 | 18 | 954.70 | 634.94 |
| 2016 | 4 | 19 | 522.20 | 477.35 |
| 2016 | 4 | 20 | 476.20 | 377.54 |
| 2016 | 4 | 21 | 513.70 | 293.20 |
| . . . | . . . | . . . | . . . | . . . |
| 2017 | 12 | 26 | 88.76 | 32.79 |
| 2017 | 12 | 27 | 35.52 | 32.93 |
| 2017 | 12 | 28 | 43.06 | 36.12 |
| 2017 | 12 | 29 | 34.14 | 38.45 |
| 2017 | 12 | 30 | 35.65 | 32.48 |
| 2017 | 12 | 31 | 34.14 | 34.14 |

A NSE efficiency coefficient and a relative error (RE) of water yield are used as evaluation indicators to evaluate the effect of the hydrological model in the validation period. The specific formulas of the NSE coefficient and the relative error (RE) of water yield are as follows:

$$NSE = 1 - \frac{{\sum }_{i = 1}^{n} {( Qsim , i - Qobs , i )}^{2}}{{\sum }_{i = 1}^{n} {( Qobs , i - \overline{Qobs} )}^{2}}$$

$$RE = \frac{{\sum }_{i = 1}^{n} Qobs , i - {\sum }_{i = 1}^{n} Qsim , i}{{\sum }_{i = 1}^{n} Qobs , i}$$

where Qsim,i represents a simulated runoff in the i period, Qobs,i represents an observed runoff in the i period, Q̅o̅b̅s̅ represents the mean value of the observed runoff, and n is the sequence length.

The results of the NSE coefficient and the relative error (RE) of water yield in the calibration period and the validation period are shown in Table 4 below:

TABLE 4

| Calibration period | Validation period |
|---|---|
| (2013-2015) | (2016-2017) |

| Model | NSE | RE (%) | NSE | RE (%) |
|---|---|---|---|---|
| The present | 0.75 | 4.04 | 0.70 | −11.7 |
| invention | | | | |
| Original | 0.68 | −9.62 | 0.62 | −17.7 |
| SIMHYD | | | | |

Table 4 shows the accuracy comparison between the present invention and the original SIMHYD model in the calibration period and the verification period. It can be seen from the table that the NSE coefficient of the present invention in both the calibration period and the verification period is higher than 0.70, the relative errors (RE) of water yield are 4.04% and −11.7%, respectively, and the absolute values thereof, within a range of 20%, are all smaller than the relative errors (RE) of water yield of the original SIMHYD model, indicating that the model of the present invention can be better used for simulation and prediction of runoffs in the watershed.

### Embodiment 2

Disclosed is a method for quantifying the impact of the uncertainty of a runoff production structure on a surface-subsurface hydrological process, namely a method for quantifying the impact of runoff production structure uncertainty on the surface-subsurface hydrological process; in this scheme, the uncertainty of the runoff production structures such as a surface runoff structure, an interflow structure and a base flow structure can be expressed by random multipliers, and the variances δ²_{IRUN}, δ²_{SRUN} and δ²_{BAS} of the random multipliers represent the runoff production structure the uncertainty of their respective runoff components (larger values indicate the greater uncertainty); in this embodiment, the optimized δ²_{IRUN}, δ²_{SRUN} and δ²_{BAS} are 0.0792, 0.5388 and 0.3212, respectively, and the impact of the runoff production structure uncertainty on the surface-subsurface hydrological process can be simulated and obtained based on the optimized variances δ²_{IRUN}, δ²_{SRUN} and δ²_{BAS} . This scheme uses random Monte Carlo sampling to simulate the impact of runoff production structure uncertainty on the surface-subsurface hydrological process.

Specifically, for the surface runoff simulation that considers the uncertainty of the surface runoff production structure, after parameter optimization, an estimated value IRŨNₜ of the surface runoff is randomly generated from the normal distribution g(IRŨNₜ|IRUNₜ,δ_{IRUN}²×IRUNₜ) with a mean of IRUNₜ and a variance of δ²_{IRUN}×IRUNₜ, and cyclic sampling is performed 1000 times to obtain the quantitative estimate of the impact of the surface runoff production structure uncertainty on the surface runoff Similarly, for the interflow simulation that considers the uncertainty of the interflow runoff production structure, after parameter optimization, an estimated value SRŨNₜ of the interflow is randomly generated from the normal distribution g(SRŨNₜ|SRUNₜ,δ_{SRUN}²×SRUNₜ) with a mean of SRUNₜ and a variance of δ²_{SRUN}×SRUNₜ, and cyclic sampling is performed 1000 times to obtain the quantitative estimate of the impact of the interflow runoff production structure uncertainty on the interflow. Similarly, for the base flow simulation that considers the uncertainty of the base flow production structure, after parameter optimization, an estimated value BÃSₜ of the base flow is randomly generated from the normal distribution g(BÃSₜ|BASₜ,δ_{BAS}²×BASₜ) with a mean of BASₜ and a variance of δ²_{BAS}×BASₜ, and cyclic sampling is performed 1000 times to obtain the quantitative estimate of the impact of the base flow production structure uncertainty on the base flow. Table 5 shows the process of surface runoff, interflow and base flow and the impact from respective uncertainties simulated in this embodiment, and defines the lower limit, mean value and upper limit of an uncertainty interval.

TABLE 5

| | | | Surface runoff (mm) | | | Interflow (mm) | | | Base flow (mm) | | |
|---|---|---|---|---|---|---|---|---|---|---|---|
| | | | Lower | Mean | Upper | Lower | Mean | Upper | Lower | Mean | Upper |
| Year | Month | Day | limit | value | limit | limit | value | limit | limit | value | limit |
| 2013 | 1 | 1 | 0 | 0 | 0 | 0 | 0 | 0 | 1.01 | 2.00 | 2.86 |
| 2013 | 1 | 2 | 0 | 0 | 0 | 0 | 0 | 0 | 0.67 | 1.24 | 1.77 |
| 2013 | 1 | 3 | 0 | 0 | 0 | 0 | 0 | 0 | 1.66 | 2.95 | 4.23 |
| 2013 | 1 | 4 | 0 | 0 | 0 | 0.24 | 0.52 | 0.84 | 0.90 | 1.62 | 2.33 |
| 2013 | 1 | 5 | 0 | 0 | 0 | 0 | 0 | 0 | 0.63 | 1.05 | 1.50 |
| 2013 | 1 | 6 | 0 | 0 | 0 | 0 | 0 | 0 | 0.86 | 1.56 | 2.27 |
| . . . | . . . | . . . | . . . | . . . | | | | | | | |
| 2016 | 4 | 16 | 0 | 0 | 0 | 4.46 | 9.59 | 14.92 | 1.31 | 2.27 | 3.22 |
| 2016 | 4 | 17 | 6.47 | 7.21 | 7.95 | 5.40 | 13.30 | 20.69 | 0.85 | 1.55 | 2.27 |
| 2016 | 4 | 18 | 0 | 0 | 0 | 0 | 0 | 0 | 1.78 | 3.15 | 4.53 |
| 2016 | 4 | 19 | 0 | 0 | 0 | 0 | 0 | 0 | 1.45 | 2.44 | 3.49 |
| 2016 | 4 | 20 | 0 | 0 | 0 | 0.22 | 0.53 | 0.86 | 1.04 | 1.79 | 2.52 |
| 2016 | 4 | 21 | 0 | 0 | 0 | 0.26 | 0.57 | 0.88 | 1.62 | 2.80 | 4.05 |
| . . . | . . . | . . . | . . . | . . . | | | | | | | |
| 2017 | 12 | 26 | 0 | 0 | 0 | 0 | 0 | 0 | 0.41 | 0.77 | 1.08 |
| 2017 | 12 | 27 | 0 | 0 | 0 | 0 | 0 | 0 | 0.49 | 0.83 | 1.16 |
| 2017 | 12 | 28 | 0 | 0 | 0 | 0 | 0 | 0 | 0.37 | 0.66 | 0.95 |
| 2017 | 12 | 29 | 0 | 0 | 0 | 0 | 0 | 0 | 0.35 | 0.60 | 0.88 |
| 2017 | 12 | 30 | 0 | 0 | 0 | 0 | 0 | 0 | 0.22 | 0.40 | 0.58 |
| 2017 | 12 | 31 | 0 | 0 | 0 | 0 | 0 | 0 | 0.47 | 0.81 | 1.16 |

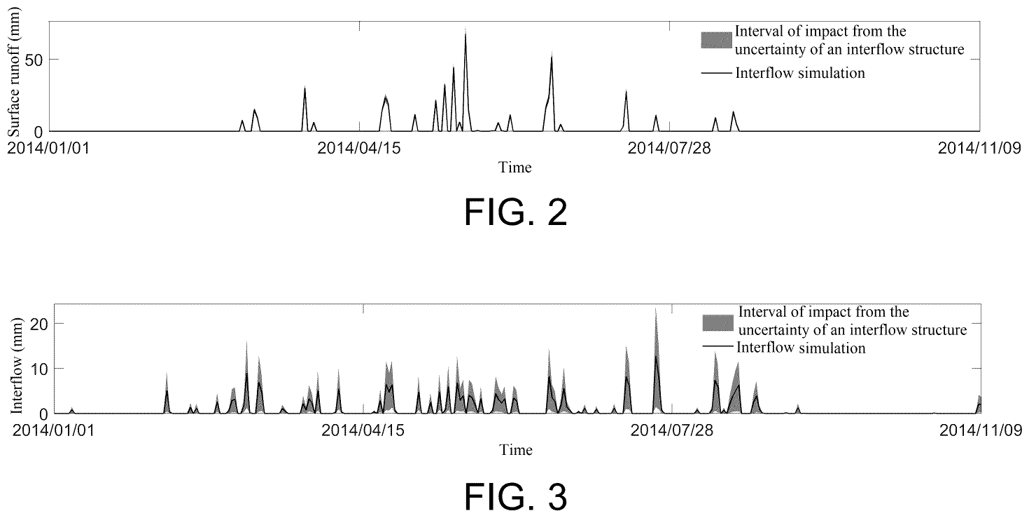

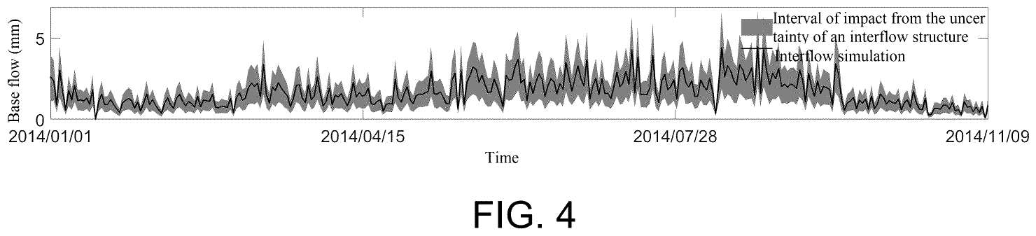

FIGS. 2-4 show the process of surface runoff, interflow and base flow and the impact from respective uncertainties in 2014 simulated in the present invention. It can be seen from Table 5 and FIGS. 2-4 that the present invention defines the uncertainty of simulating the surface runoff, interflow and base flow caused by the uncertainty of the runoff production structures such as a surface runoff structure, an interflow structure and a base flow structure. It can be seen from the interval of impact from the uncertainty of the three runoff production structures that the base flow uncertainty has a great impact, and the uncertainty caused by the base flow structure exists at all times of the year.

### Embodiment 3

The runoff the uncertainty of the three runoff components will also have an impact on the simulation and prediction of the flow rate at the outlet of the watershed, according to the estimate results about the uncertainty of the runoff yield of each of the three runoff components (surface runoff, interflow and base flow), the three kinds of runoff components, in the same sampling scenario, are superimposed to obtain the runoff yield of the whole watershed, and then according to the watershed confluence formula and the optimized confluence parameters CR, the flow rates at the outlet of the watershed under different random sampling scenarios are calculated to obtain 1000 kinds of processes of flow at the outlet of the watershed, which represents the impact of runoff production structure uncertainty on simulation of the flow rate at the outlet of the watershed.

TABLE 6

| | | | Measured | Lower | Mean | Upper |
|---|---|---|---|---|---|---|
| | | | runoff | limit | value | limit |
| Year | Month | Day | (m³/s) | (m³/s) | (m³/s) | (m³/s) |
| 2013 | 1 | 1 | 120.90 | 117.87 | 160.85 | 210.35 |
| 2013 | 1 | 2 | 112.90 | 105.75 | 147.62 | 186.76 |
| 2013 | 1 | 3 | 112.90 | 87.07 | 141.89 | 170.74 |
| 2013 | 1 | 4 | 121.10 | 88.79 | 126.96 | 169.91 |
| 2013 | 1 | 5 | 133.30 | 82.43 | 101.23 | 163.57 |
| 2013 | 1 | 6 | 129.10 | 74.50 | 106.06 | 147.62 |
| . . . | . . . | . . . | . . . | . . . | . . . | . . . |
| 2016 | 4 | 16 | 845 | 578.79 | 689.78 | 898.82 |
| 2016 | 4 | 17 | 777 | 736.58 | 846.37 | 1101.63 |
| 2016 | 4 | 18 | 954.70 | 548.17 | 634.94 | 805.42 |
| 2016 | 4 | 19 | 522.20 | 417.03 | 477.35 | 610.87 |
| 2016 | 4 | 20 | 476.20 | 318.67 | 377.54 | 469.48 |
| 2016 | 4 | 21 | 513.70 | 254.96 | 293.20 | 368.86 |
| . . . | . . . | . . . | . . . | . . . | . . . | . . . |
| 2017 | 12 | 26 | 88.76 | 20.75 | 32.79 | 46.27 |
| 2017 | 12 | 27 | 35.52 | 21.17 | 32.93 | 47.19 |
| 2017 | 12 | 28 | 43.06 | 20.21 | 36.12 | 48.59 |
| 2017 | 12 | 29 | 34.14 | 20.67 | 38.45 | 44.37 |
| 2017 | 12 | 30 | 35.65 | 19.99 | 32.48 | 45.26 |
| 2017 | 12 | 31 | 34.14 | 19.51 | 34.14 | 43.69 |

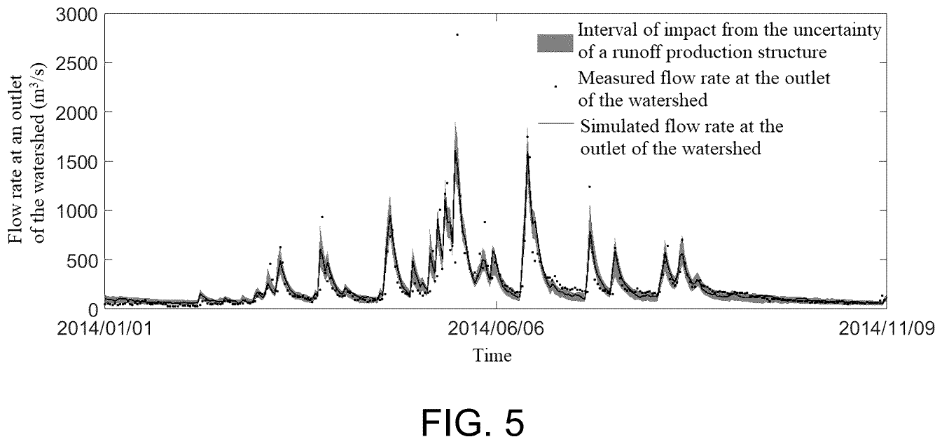

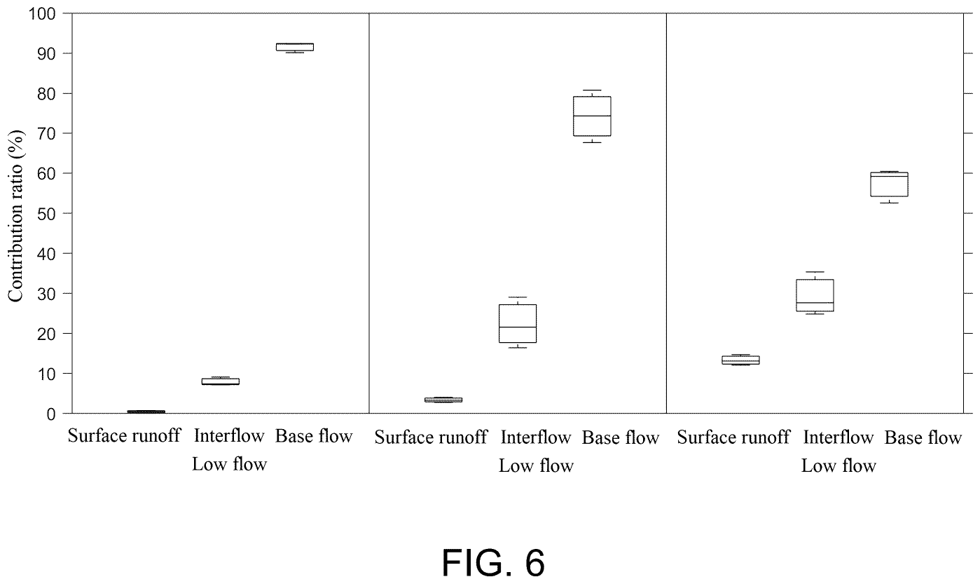

FIG. 6 shows the impact from variation of flow rates at an outlet of the watershed and the uncertainty of a runoff production structure simulated in this embodiment, and defines the lower limit, mean value and upper limit of the uncertainty interval. FIG. 5 shows the impact from variation of flow rates at an outlet of the watershed and the uncertainty of a runoff production structure simulated in this embodiment. It can be seen from Table 6 and FIG. 5 that when the uncertainty of the runoff production structure is considered, the obtained uncertainty interval has a good coverage of the measured process of flow at the outlet of the watershed, and at the same time, has a good degree of closeness to the measured process of flow at the outlet of the watershed. In addition, a good uncertainty interval also provides a good reference for quantitatively describing the impact of the uncertainty of the runoff production structure on simulation of the runoff at the outlet of the watershed.

### Embodiment 4

The contribution ratios of the three runoff components to the total runoff production uncertainty at different times are analyzed, and specifically, the contribution ratios of uncertainties of the three runoff production structures to low flow (less than 200 m³/s), medium flow (200-800 m³/s) and high flow (above 800 m³/s) are calculated every year. FIG. 6 shows contribution ratios of uncertainties of different runoff production structures including a surface runoff structure, an interflow structure and a base flow structure to runoff production uncertainty, and each set of box lines consists of statistical results for 2013, 2014 and 2015. It can be seen from FIG. 6 that in the low flow period, the estimated the uncertainty of the base flow of the model is significantly larger than that of the surface runoff and the interflow, and its contribution accounts for 90%-92%; with an increase in the flow, the contribution of the uncertainty of the interflow and the surface runoff gradually increases; and in the high flow period, the contribution ratio of the interflow reaches 25%-35%, and the contribution ratio of the surface runoff reaches 12%-15%. In combination with FIGS. 2-4, it can also be seen that the uncertainty of the surface runoff has a greater impact on the typical high-flow flood process, which is favorably consistent with the physical law of runoff production. It indicates that the present invention describes the uncertainty caused by different runoff components in the runoff production structure and its quantitative results more elaborately, and has a good reference value for understanding and improving the hydrological model.

Generally speaking, the hydrological model of the present invention has higher accuracy than the original hydrological model, and is capable to quantitatively estimate the impact of different runoff components in the runoff production structure of the hydrological model on the simulation and prediction of the surface-subsurface hydrological process. In addition, estimation results about certainty and the uncertainty of the surface-subsurface hydrological process are given. Compared to traditional hydrological models, the hydrological model has better application value and prospects.

As above, although the present invention has been shown and described with reference to specific preferred embodiments, this should not be construed as limiting the present invention. Various changes in forms and details can be made therein without departing from the spirit and scope of the present invention as defined by the appended claims.

What is claimed is:

1. A hydrological model considering an uncertainty of a runoff production structure, comprising the following steps:
step S(1) collecting data: collecting an observation sequence of hydrometeorological stations in a watershed, including data of precipitation, water surface evaporation and runoff observed by the hydrometeorological stations in the watershed;
step S(2) calculating runoff production: establishing a runoff production calculation module based on a structure of a SIMHYD model, and mainly including calculating four parts including evaporation loss, soil infiltration, water storage and runoff production;
step S(3) dealing with the uncertainty of the runoff production structure: assuming that differences between runoff yields of different runoff components of the SIMHYD model and real runoff yields follow a normal distribution, that is, a product of multiplying a runoff yield of each of three runoff components of the SIMHYD model with a random number following the normal distribution is equal to a corresponding real runoff yield, the three runoff components including surface runoff, interflow and base flow;
for the surface runoff, the random number following the normal distribution is quantitatively expressed as a random number of normal distribution with a mean of m_{IRUN} and a variance of δ²_{IRUN}; for the interflow, the random number following the normal distribution is quantitatively expressed as a random number of normal distribution with a mean of m_{SRUN} and a variance of δ²_{SRUN}; for the base flow, a random number following the normal distribution is quantitatively expressed as a random number of normal distribution with a mean of m_{BAS} and a variance of δ²_{BAS}; variances δ²_{IRUN}, δ²_{SRUN} and δ²_{BAS} respectively represent uncertainties of runoff production structures including a surface runoff structure, an interflow structure and a base flow structure;
step S(4) calculating a confluence: using a lag-and-route method to adjust a total outflow process of the SIMHYD model considering the uncertainty of the runoff production structure, so as to consider a river channel confluence;
step S(5) optimizing parameters: selecting a runoff sequence observed by the hydrometeorological stations at an outlet of the watershed in a continuous year, defining a calibration period and validation period, using a NSE coefficient as an objective function, taking a maximization of an NSE coefficient as an optimization objective, using a Shuffled Complex Evolution (SCE-UA) algorithm as a global optimization algorithm, inputting an average areal precipitation in the watershed in the calibration period, average areal evaporation from water surface and runoff observed at the outlet of the watershed, setting upper and lower boundary values for parameters to be optimized, and optimizing the parameters of the hydrological model; and
step S(6) substituting the optimized parameter values into the validation period to calculate and obtain values of simulated runoffs in the calibration period and the validation period.

2. The hydrological model considering the uncertainty of the runoff production structure according to claim 1, wherein in the step S(1), the precipitation and evaporation from water surface observed by the hydrometeorological stations in the watershed are further converted to the average areal precipitation in the watershed and the average areal evaporation from water surface, and a multi-site arithmetic averaging method is adopted as a conversion method:
$${\overline{PE}}_{t} = {{\sum }^{n}}_{i} {PE}_{i , t} / n$$
where PE_{i,t} represents the precipitation or evaporation from water surface observed by a station i at time t, n represents a total number of stations in the watershed, and PĒₜ represents the average areal precipitation in the watershed or the evaporation from water surface at time t.

3. The hydrological model considering the uncertainty of the runoff production structure according to claim 1, wherein a formula for the step S(4) calculating the confluence is as follows:
Qₜ=CR×Qₜ₋₁+(1−CR)×(IRŨNₜ+SRŨNₜ+BÃSₜ)
where Qₜ is a flow rate at the outlet of the watershed at time t, m³/s; CR is a coefficient of extinction for channel storage, IRŨNₜ represents an actual surface runoff at time t, SRŨNₜ represents an actual interflow at time t, and BÃSₜ an actual base flow at time t.

4. The hydrological model considering the uncertainty of the runoff production structure according to claim 1, wherein in the step S(5), the parameters of the hydrological model comprise intercepted precipitation storage capacity, maximum infiltration loss, soil moisture storage capacity, interflow outflow coefficient, infiltration loss index, subsurface water replenishment coefficient, subsurface runoff coefficient, mean random multiplier of the surface runoff, mean random multiplier of the interflow, mean random multiplier of the base flow, variance of a random multiplier of the surface runoff, variance of a random multiplier of the interflow, variance of a random multiplier of the base flow, and coefficient of extinction for channel storage.

5. A method for quantifying an impact of an uncertainty of a runoff production structure on a surface-subsurface hydrological process according to the hydrological model of claim 1, wherein random Monte Carlo sampling is used to simulate an impact of runoff production structure uncertainty on the surface-subsurface hydrological process; for a surface runoff simulation that considers the uncertainty of a surface runoff production structure, after parameter optimization, an estimated value IRŨNₜ of the surface runoff is randomly generated from the normal distribution g(IRŨNₜ|IRUNₜ,δ_{IRUN}²×IRUNₜ) with a mean of IRUNₜ and a variance of δ²_{IRUN}×IRUNₜ, and cyclic sampling is performed N times to obtain a quantitative estimate of the impact of the surface runoff production structure uncertainty on the surface runoff; for an interflow simulation that considers the uncertainty of an interflow runoff production structure, after parameter optimization, an estimated value SRŨNₜ of the interflow is randomly generated from the normal distribution g(SRŨNₜ|SRUNₜ,δ_{SRUN}²×SRUNₜ) with a mean of SRUNₜ and a variance of δ²_{SRUN}×SRUNₜ, and cyclic sampling is performed N times to obtain a quantitative estimate of the impact of the uncertainty of the interflow runoff production structure on the interflow; and for a base flow simulation that considers a uncertainty of the base flow production structure, after parameter optimization, an estimated value BÃSₜ of the base flow is randomly generated from the normal distribution g(BÃSₜ|BASₜ,δ_{BAS}²×BASₜ) with a mean of BASₜ and a variance of δ²_{BAS}×BASₜ, and cyclic sampling is performed N times to obtain a quantitative estimate of the impact of the uncertainty of the base flow production structure on the base flow.

6. The method for quantifying the impact of the uncertainty of the runoff production structure on a surface-subsurface hydrological process according to claim 5, wherein the three runoff components, in a same sampling scenario, are superimposed to obtain a runoff yield of the whole watershed, and then according to a watershed confluence formula and an optimized confluence parameters CR, the flow rates at the outlet of the watershed under different random sampling scenarios are calculated to obtain N kinds of processes of flow at the outlet of the watershed, which represents the impact of the uncertainty of the runoff production structure on a simulation of the flow rate at the outlet of the watershed.

7. The method for quantifying the impact of the uncertainty of a runoff production structure on a surface-subsurface hydrological process according to claim 6, wherein N is set to 1000, that is, cyclic sampling is performed for 1000 times.
